(19) United States
(12) Patent Application Publication
(10) Pub. No.: US 2003/0117576 A1
(43) Pub. Date: Jun. 26, 2003

(54) Colored contact lenses

(75) Inventors: Ashok R. Thakrar, San Jose, CA (US); J. Christopher Marmo, Danville, CA (US)

Correspondence Address: STOUT, UXA, BUYAN & MULLINS LLP, 4 VENTURE, SUITE 300, IRVINE, CA, 92618, US

(73) Assignee: Ocular Sciences, Inc., Concord, CA (US)

(21) Appl. No.: 10/306,726

(22) Filed: Nov. 27, 2002

Related U.S. Application Data
(60) Provisional application No. 60/337,582, filed on Dec. 5, 2001.

(51) Int. Cl. G02C 7/04

(52) U.S. Cl. 351/162

(57) ABSTRACT

A tinted or colored contact lens has a pupil section, an iris section having an area and circumferentially surrounding the pupil section, and a colorant component extending across a major portion of the area of the iris section. The colorant component provides a color to the iris section and at least one additional benefit to the contact lens. For example, the colorant component may enhance the natural appearance of the iris section when the contact lens is in an eye. Alternatively or in addition, the colorant component may enhance the perception of depth in the iris section by an ordinary viewer. Still further, the colorant component may provide a darkened-image within an outer portion of the iris section.

### RELATED APPLICATION

This application claims the benefit of Provisional U.S. Patent Application Serial No. 60/337,582 filed Dec. 5, 2001, the disclosure of which is incorporated in its entirety herein by reference.

### BACKGROUND OF THE INVENTION

The present invention relates to contact lenses and methods of or processes for making contact lenses. More particularly, this invention relates to tinted contact lenses and processes for making tinted contact lenses.

For several decades, tinted contact lenses have been available for those who wish to temporarily alter their eye color. As tinted contact lenses have grown in popularity, and in conjunction with improvements in contact lens technology, there has been an increase in demand for tinted contact lenses.

Examples of various tinted or colored contact lens may be found in Knapp U.S. Pat. No. 4,582,402, Rawlings et al U.S. Pat. No. 5,120,121, Evans et al U.S. Pat. No. 5,302,978, and Jahnke U.S. Pat. No. 5,414,477. The disclosure of each of these patents is incorporated in its entirety herein by reference.

There continues to be a need for enhanced tinted contact lenses. For example, it would be advantageous to provide tinted contact lenses that more effectively change the eye color of the lens wearer and/or provide a more natural looking or appearing iris structure.

### SUMMARY OF THE INVENTION

New tinted contact lenses and processes for making tinted contact lenses have been discovered. The present invention provides tinted contact lenses which have significant advantages over lenses of the prior art. For example, the present tinted lenses are very effectively colored to provide the lens wearer with a desired eye color change or alteration, preferably while muting the natural color of the wearer's eye to further enhance the color change or alteration. In addition, the present tinted contact lenses advantageously give the wearer's eye a very natural appearance. Moreover, the tinted lenses of the present invention are comfortable and safe to wear, and can be cost effectively produced in a relatively straightforward manner.

In accordance with one aspect of the invention, tinted contact lenses are provided which comprise a pupil section, an iris section having an area and circumferentially surrounding the pupil section, and a colorant component extending across a major portion, preferably substantially all, of the area of the iris section. The colorant component provides a color to the iris section and is configured to provide at least one additional benefit to the contact lens. For example, the colorant component may be configured to enhance the natural appearance of the iris section when the contact lens is in an eye. Alternatively and/or in addition, the colorant component may be configured to provide the iris section with an enhanced perception of depth (or a perceived three-dimensional effect), which perception can enhance the natural appearance of an eye wearing a tinted contact lens of the present invention. Still further, the colorant component may be configured to provide a darkened-image within an outer portion of the iris section. It should be noted that the tinted contact lenses of the present invention may be otherwise configured to enhance the natural appearance of the iris section and/or to provide the iris section with an enhanced perception of depth (or perceived three-dimensional effect).

Desirably, the color provided to the iris section by the colorant component is that color to which a wearer of the contact lens wishes to change the natural color of his/her iris. Preferably, the colorant component extends across substantially all of the area of the iris section. The colorant component preferably is non-uniform, preferably has a non-uniform density, across the area of the iris section, such as radially non-uniform. Advantageously, the non-uniformity of the colorant component is sufficient to provide the iris section with an enhanced perception of depth when the contact lens is worn, relative to a substantially identical contact lens with a uniform colorant component.

As used in the context of the density of a colorant component in accordance with the present invention, the term “density” means the portion or percent of a surface, for example, the surface or portion of the surface of the iris section of a contact lens, covered by the colorant component of the surface on which the colorant component is located or over which the colorant component extends. To illustrate, if the colorant component extends over the entire iris section and covers 40% of the iris section, the density of the colorant component is 40%. In another example, if the colorant component is located on or extends over only 70% of the iris section and covers 40% of that 70% of the iris section, the density of the colorant component is 40%.

In one embodiment, the colorant component is less dense, that is has reduced density, near the pupil section then farther outward from the pupil section and/or is less dense near an outer periphery of the iris section then farther inward from the outer periphery. The minimum density of the colorant component, in terms of the percent of area of the iris section covered thereby, as defined above, is about 35% or less or about 30% or less, for example, about 1% or about 5% to about 30%, while the maximum density is about 40% or more, for example, about 40% to about 80% or about 90%.

The tinted contact lenses of the present invention may, and preferably do, include a peripheral section circumferentially surrounding the iris section, which peripheral section advantageously is substantially free of the colorant component, and more preferably is optically clear.

The colorant component may include a single colorant, or a plurality of colorants, that is at least two different colorants.

In one embodiment, the colorant component includes a dark colorant extending across a portion of the area of the iris section to provide a darkened-image within an outer portion of the iris section. The darkened-image may be a series of spaced apart segments of the dark colorant. The darkened-image may be configured so as to be perceived as having a structure similar to the naturally occurring dark ring of the eye. However, unlike this naturally occurring dark ring, which extends outwardly beyond the outer periphery of the iris of the eye, the present darkened image is advantageously positioned within the iris section of the contact lens, rather than outside the iris section in the peripheral section of the lens. In one embodiment, the dark colorant is separate and apart from the colorant component, for example, is applied to the contact lens or contact lens substrate separate from the colorant component. Both embodiments, that is with the dark colorant as part of the colorant component and with the dark colorant separate and apart from the colorant component, are included within the scope of the present invention.

The present tinted contact lenses may include at least one colored-pattern extending across a portion of the area of the iris section to impart to the iris section at least a perception of the structure of an iris of an eye, for example, at least a perception of the structure of a natural iris of a human eye. The colored-pattern advantageously has a different color than the colorant component. In one embodiment, the tinted contact lens may include two colored-patterns, each of which preferably is differently colored.

The at least one colored-pattern advantageously extends outwardly from a periphery, or from near the periphery, of the pupil section toward the outer periphery of the iris section, and preferably more than about 95% of the radial distance therebetween, that is between the periphery of the pupil section and the outer periphery of the iris section. The at least one colored-pattern preferably does not contact the outer periphery of the iris section. In one useful embodiment, the colored pattern extends to within less than about 5% of the radial distance between the periphery of the pupil section and the outer periphery of the iris section of (1) the periphery of the pupil section and/or (2) the outer periphery of the iris section. Desirably, at least one location, and preferably at a plurality of locations, a plane extending from the periphery of the pupil section to the outer periphery of the iris section, and preferably through the optical axis of the lens, does not intersect the colored-pattern. In other words, the at least one colored-pattern is advantageously discontinuous at at least one location, preferably at a plurality of locations, on the lens.

In one particularly useful embodiment, the at least one colored pattern comprises a plurality of substantially completely colored regions each of which becomes a series of spaced apart colored segments near the periphery of the pupil section. Such configuration very effectively provides at least the perception of the structure of an iris to the tinted contact lens while advantageously reducing the interference with the lens wearer's vision which would otherwise occur if the at least one colored-pattern were to be completely colored near the periphery of the pupil section, that is if the at least one colored-pattern did not include the above-noted spaced apart colored segments near the periphery of the pupil section. The spaced apart colored segments may be less intensely colored relative to the remainder of the at least one colored pattern. In other words, the spaced apart colored segments may have a color which is faded or muted relative to the color of the majority or major portion, i.e., at least about 50%, of the colored pattern.

The present tinted contact lenses may, and preferably do, include a second colorant component, different from the colorant component described above (sometimes herein referred to as the first colorant component), and extending across a major portion, or substantially all, of the area of the iris section. The second colorant component is light absorbing, for example, is of a color which is more light absorbing, for example, more dark, than the colorant component, and is effective to enhance the ability of the contact lens to change the color of an iris of an eye wearing the contact lens relative to a substantially identical contact lens without the second colorant component. Without wishing to limit this invention to any particular theory of operation, it is believed that the second colorant component is effective to mute or reduce the effect of the natural color of the lens wearer's iris. This, in turn, allows the lens wearer's iris to more effectively appear to take on the color of the colorant component. The second colorant component may extend across all of the area of the iris section, and may be substantially uniform with a density between about 5% to about 70% or about 90%.

The contact lenses, for example, tinted contact lenses, of the present invention may comprise a substantially optically clear coating covering the colorant component that is effective to provide increased comfort in wearing the lens relative to a substantially identical lens without the coating. The coating may have a thickness of less than about 20 microns, preferably less than about 10 microns. Advantageously, the colorant component is located on an anterior surface of a contact lens substrate and the coating forms the anterior surface of the tinted contact lens. The coating may be a hydrophilic polymeric material, and may be, and preferably is, cross-linked.

In one embodiment, the clear coating covers only that surface of the contact lens substrate on which the colorant component is located. For example, if the colorant component is placed on the anterior face of the contact lens substrate, the clear coating preferably is placed only on the anterior face of the lens substrate. The posterior face of the lens, which is substantially free of colorant components and colored patterns, preferably is substantially free of such a coating. Using such a coating on only the surface with the colorant component reduces the overall thickness of the lens and enhances the ease of wearing this lens while increasing the comfort of the lens wearer. In effect, placing the clear coating only on the surface of the lens substrate on which the colorant component is located enhances the comfort of the lens wearer relative to a substantially identical tinted lens including a clear coating on both anterior and posterior surfaces of the lens. In addition, having the clear coating on only one surface of the lens advantageously provides for enhanced oxygen permeability, particularly through the pupil section or optical region of the lens, relative to an identical tinted lens with clear coatings on both anterior and posterior surfaces. Such advantage is believed to be at least in part related to the reduced thickness of the lens having the clear coating on only one surface of the lens.

The tinted contact lens in the present invention may include a dark colorant, other than the colorant component, configured to provide a darkened-image within an outer portion of the iris section, as discussed previously.

In an additional aspect of the present invention, processes for making tinted contact lenses, for example, the present tinted contact lenses, are provided. In one embodiment, the process includes providing a substrate, for example, a contact lens substrate, placing a colorant component across a major portion of an annular iris section of the substrate, with the colorant component being configured to provide at least one additional benefit to the tinted contact lens. In a useful embodiment, the colorant component comprises a plurality of discrete elements.

A further aspect of the present invention includes a process of forming a tinted contact lens comprises the following steps, preferably in the following order:

placing a first colorant component across at least a major portion of an area of an iris section of a contact lens substrate;

placing at least one colored pattern that simulates a structure of a naturally occurring iris of an eye across a portion of the area of the iris section of the substrate; and

placing a second light absorbing colorant component across a major portion of the area of the iris section of the substrate.

Desirably, the process further includes a step of placing a dark colorant on an outer portion of the iris section separately from or at substantially the same time as the step or steps of placing the first colorant component and/or the second colorant component. The process may include a step of placing a clear coating on the substrate, the coating preferably covering the first and second colorant components and the at least one colored pattern.

Each and every feature described herein, and each and every combination of two or more of such features, is included within the scope of the present invention provided that the features included in such a combination are not mutually inconsistent.

Additional aspects and advantages of the present invention are set forth in the following description, particularly when considered in conjunction with the accompanying drawings in which like parts bear like reference numerals.

### BRIEF DESCRIPTION OF THE DRAWINGS

FIG. 1A is a front view of a colored contact lens of the present invention;

FIG. 1B is a vertical sectional view through the lens of FIG. 1A;

FIG. 2 is a front view of a contact lens of the present invention having a colorant component with one colorant thereon;

FIG. 2A is an enlarged view of a peripheral portion of the colorant component of the lens of FIG. 2 illustrate one arrangement of colorant elements;

FIG. 3 is a front view of a colored contact lens of the present invention having a colorant component with first and second colorants thereon;

FIGS. 4A-4D are enlarged views of a peripheral portion of the colorant component of the lens of FIG. 3 illustrating various arrangements of the colorant elements of the first and second colorants;

FIG. 5 is a front view of a colored contact lens of the present invention with a non-uniform colorant component thereon having different densities;

FIG. 5A is an enlarged view of an area of the colorant component of the lens of FIG. 5 showing the interface between regions of different colorant element density;

FIG. 6 is a front view of a colored contact lens of the present invention with a dark colorant extending across a portion of an iris section to provide a darkened image;

FIG. 7 is a front view of a colored contact lens of the present invention having both the non-uniform colorant component of FIG. 5 and the dark colorant of FIG. 6 thereon;

FIG. 8A is a front view of a contact lens of the present invention having a colored pattern thereon;

FIG. 8B is a representation of a front view of a complete contact lens of the present invention.

FIG. 9 is a front view of a contact lens of the present invention having a colored pattern thereon with spaced apart colored segments adjacent a pupil section of the lens;

FIG. 10 is a front view of a colored contact lens of the present invention having a dark colorant, first and second colorant components, and a colored pattern;

FIG. 10A is an enlarged view of an area of the lens of FIG. 10; and

FIG. 11 is an exploded perspective view of a number of colorants/elements in an exemplary tinted contact lens of the present invention.

FIG. 12 is an exploded perspective view of a number of colorants/elements in an alternate tinted contact lens of the present invention.

### DESCRIPTION OF THE PREFERRED EMBODIMENTS

FIGS. 1A and 1B illustrate a number of conventional components of a contact lens 20 for purpose of reference. It is not intended to limit the present invention to only such conventionally structured contact lenses. The lens 20 is circular in front view and concave/convex so as to possess a crescent-shaped vertical cross-section through a midplane as seen in FIG. 1B. Several concentric regions as seen in FIG. 1A are disposed about a central optical axis OA. Namely, a pupil section 22 encompasses the optical axis OA and extends radially outward therefrom to form a central circular area. An annular iris section 24 concentrically surrounds the pupil section 22 and typically defines a majority of the surface area of the contact lens 20. Finally, the contact lens 20 may include an annular peripheral section 26 disposed concentrically about the iris section 24. The circular lines denoting the periphery of the pupil section 22 and the outer periphery of the iris section 24 are shown for illustration purposes. Such lines do not actually appear on the contact lenses. The various embodiments of the colored or tinted contact lenses of the present invention will be consistently described utilizing the numbering scheme of FIGS. 1A and 1B for the various concentric sections.

For purpose of example, with reference to FIG. 1A, the pupil section 22 typically has a radius of about 2 mm to about 3 mm, and preferably has a radius of about 2.5 mm. The outer periphery of the iris section 24 is located at a radial distance of greater than about 2 mm to about 7 mm, and preferably at a radial distance of about 6.3 mm, from the central optical axis OA. The outer periphery (outer lens edge) of the peripheral section 26 typically is located at a radial distance of about 6 mm to about 8 mm, and preferably at a radial distance of about 7.3 mm, from the central optical axis OA.

FIG. 1B illustrates a convex front or anterior surface or face 28 and a concave rear or posterior surface or face 30. The concave posterior surface is adapted to face and conform to the cornea of an eye when the lens is worn. The lens 20 is shown as a crescent shape in cross-section such that the outer edge 32 is relatively thinner than the middle regions of the lens. It should be noted here that the elements of color utilized in the contact lens 20 may be deposited or otherwise formed on either the anterior surface 28 or the posterior surface 30.

Colorant Component

In one aspect, the present invention provides a tinted or colored contact lens comprising a colorant component extending across at least a major portion, that is at least about 50%, of the area of the iris section of the contact lens. The colored contact lens permits the wearer to make a change from his or her natural eye color when the contact lens is placed in the eye, such as onto or covering an iris of the eye. In one embodiment, the colorant component is configured to enhance the natural appearance and/or perception of depth of the iris section of the tinted contact lens when the lens is worn. Preferably, the color provided to the iris section by the colorant component is that color to which a wearer of the contact lens wishes to change his or her iris by wearing the lens. In one embodiment, the present tinted contact lenses do not rely on the structure, for example the iris structure, of the wearer's eye to give a natural appearance to the tinted contact lens. In other words, in one embodiment, and preferably, the present tinted lens is such that at a reasonable distance, e.g., about five feet, an ordinary viewer, on viewing the wearer's eyes, is not able to see or visualize the wearer's iris, that is the structure of the wearer's iris, through the tinted contact lens. An “ordinary viewer” in this context is defined as a person of ordinary vision standing approximately five feet away from the wearer of the tinted contact lens.

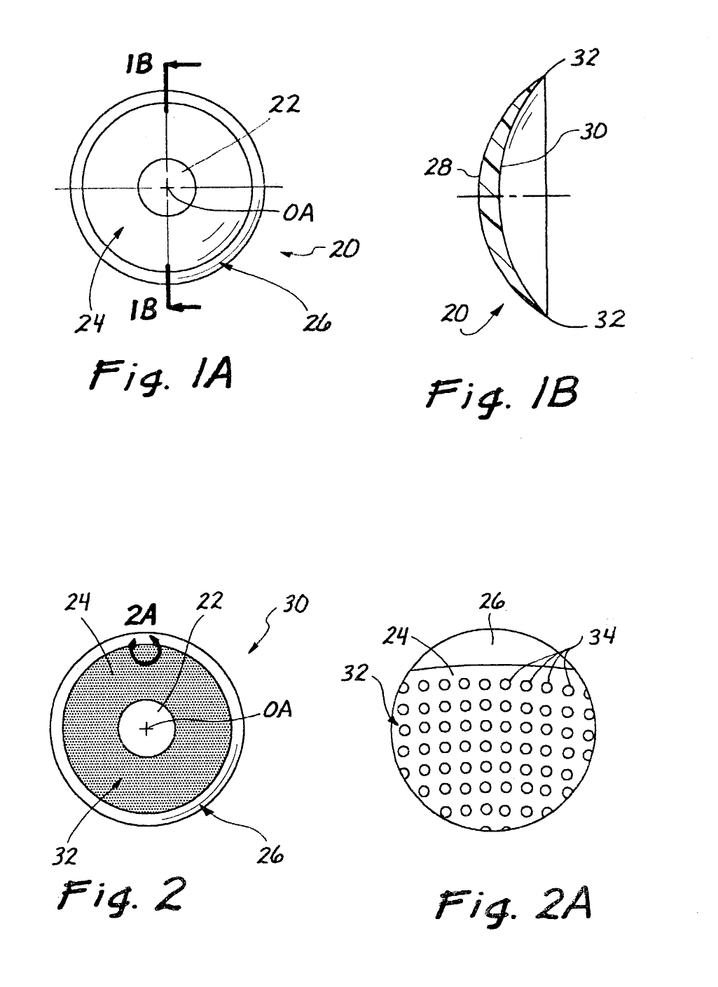

FIG. 2 shows a colored contact lens 30 of the present invention having a colorant component 32 disposed within an iris section 24. Preferably, the colorant component 32 has or spans an area extending across at least a major portion of the area of the iris section 24 to provide a color thereto. More preferably, the colorant component 32 covers or extends over substantially all of the area of the iris section 24. The colorant component 32 can thus be viewed as a flood colorant or flood coat that saturates the iris section 24 and provides a canvas of sorts on which other natural iris features may be simulated. In most cases, one or both of the pupil section 22 and the peripheral section 26 are substantially free of the colorant component 32, and more preferably are optically clear. Indeed, the pupil section 22 and the peripheral section 26 are both preferably defined at the termination of any colorants in the iris section 24.

In one embodiment as seen in FIG. 2A, the colorant component 32 comprises an arrangement of discrete colorant elements 34, preferably formed on the lens substrate, distributed across or extended over at least a major portion of the iris section 24. The colorant elements 34 may have any shape, regular or irregular, such as round, square, hexagonal, elongated, etc. See, for example, the various shapes disclosed in Jahnke U.S. Pat. No. 5,414,477, the disclosure of which is incorporated herein in its entirety by reference. The specific shape of each of the elements 34 is not critical to the present invention, provided that there are enough color elements 34 to provide a desired color to the iris section 24. Likewise, the size of elements 34 is not critical and may be substantially constant or may vary deliberately or as a consequence of the manufacturing process.

The colorant elements 34 may be formed on the lens 30 in various spatial arrangements, but the overall pattern forms a concentric ring around the pupil section 22. Depending on the density and regularity of distribution of the colorant elements 34, it may be possible to trace a radial line originating from the optical axis OA to the outer periphery of the iris section 24 without intersecting one of the elements. Alternatively, the colorant elements 34 are so arranged or are provided in such density that such a radial line will intersect at least one of the elements. It should be noted that at least some of the discrete colorant elements 34 may overlap and thus combine to form discrete elements that cover larger surface areas. Again, this configuration may be deliberate or may be a natural consequence of the manufacturing process.

The colorant component 34 may comprise two or more differently colored or shaded elements 34. For example, colorant elements 34 of both green and opaque yellow may be combined. It will be understood by those of skill in the art that various color combinations can be utilized to effect desired iris color appearances. Also, as described above, the differently colored elements 34 may be discrete or spaced apart on the iris section 24, or may overlap in a regular or irregular manner. Examples of such overlap will be described below with respect to FIGS. 4A-4D.

In a preferred embodiment, the colorant component 32 prevents an ordinary viewer, for example, a person viewing the lens on a wearer's eye from about 5 feet or about 10 feet, from seeing the color and/or structure of the natural iris of the wearer. That is, colorant component 32 substantially occludes the natural iris color and/or structure. In a very useful embodiment, colorant component 32 is configured to allow light to pass through the contact lens and to reflect off of the surface, e.g., iris surface, of the lens wearer's eye. This feature, which can be obtained by selecting or controlling the density of the colorant component on the iris section of the lens and/or the degree of translucency and/or opaqueness of the colorant component, enhances the perception of depth of an eye of a wearer of the lens given to an ordinary viewer relative to an identical tinted contact lens the iris section of which is completely opaque.

Multiple Colorant Components

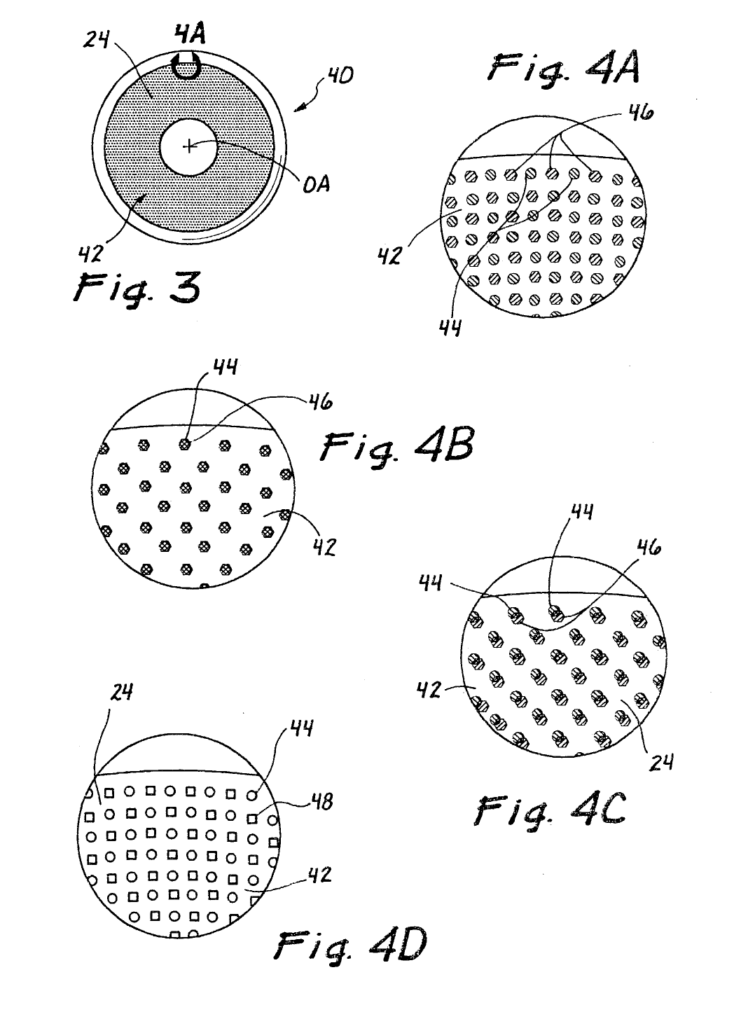

In accordance with an exemplary embodiment of the present invention, a tinted contact lens 40, such as seen in FIG. 3, comprises multiple colorant components, such as the colorant component 32 described above with respect to the lens 30 of FIG. 2. In FIG. 3, a multiple colorant component region 42 is seen spanning across or extending over substantially the entire iris section 24, although the arrangement of the different colorant components is such that they cannot be distinguished at the particular magnification and as reproduced here in black and white. To better illustrate and distinguish the colorant components, their respective elements are seen magnified in several different configurations in FIGS. 4A-4D.

As described above, the colorant components of the lens 40 each comprises multiple colorant dots or elements formed on the lens substrate in particular on the iris section 24. These colorant elements may be provided in a variety of shapes and sizes. For example, FIG. 4A illustrates first colorant elements 44 of a first colorant component within the region 42 of the iris section 24, and second colorant elements 46 of a second colorant component within the region 42 of the iris section 24. The first colorant elements 44 are illustrated as circular, while the second colorant elements 46 are hexagonal, although it will be understood that both colorant elements 44, 46 may be circular or hexagonal, or provided in other regular and/or irregular shapes. FIG. 4A shows the two colorant elements 44, 46 as non-overlapping and arrayed in a regular grid, specifically in concentric circles radiating about the optical axis OA. Moreover, there are an equal number of the circular colorant elements 44 and hexagonal colorant elements 46, although the proportion may vary across the entire multiple colorant component region 42 or only in certain areas.

In contrast to FIG. 4A, FIG. 4B illustrates an arrangement of colorant elements 44, 46 within the multiple colorant component region 42 of iris section 24 in which the elements substantially or completely overlap. Such an arrangement creates a blended color from the two colorant elements 44, 46, as long as the element on top does not completely occlude the element below. As in the distribution of FIG. 4A, the overlapping elements 44, 46 in FIG. 4B are regularly arranged in concentric circles about the optical axis OA, although such a distribution is not considered to limit the present invention.

FIG. 4C illustrates a regular distribution of partially overlapping elements 44, 46 on region 42 of iris section 24. Again, this arrangement creates a blended color from the different colors or shades of the elements 44, 46. Those of skill in the art will recognize that one or the other of elements 44, 46 may overlap the other so as to be a dominant or primary colorant component with undertones of the secondary colorant component. The extent of overlap determines the relative dominance, and infinite color schemes are possible.

FIG. 4D shows a regular distribution of non-overlapping first and second colorant elements 44, 48, respectively, on region 42 of iris section 24. In contrast to the configuration of FIG. 4A, and for the purpose of illustration, the second colorant component has elements 48 that are square as opposed to hexagonal. The elements can have any suitable shape or combination of shapes, such as regular shapes, irregular shapes and combinations thereof.

Light Absorbing Colorant Components

In one embodiment, the elements 44, 46 of the first and second colorant components within the region 42 of iris section 24 are opaque. Alternatively, however, one of the colorant components may have elements that are light absorbing, which is defined as the capability of absorbing light to a relatively high degree. For example, the light absorbing (second) colorant component has an increased ability to absorb visible light relative to the other (first) colorant component. In a very useful embodiment, the light absorbing colorant component is effective to absorb a substantial portion of the visible light, for example, a major portion of the visible light or at least about 70% of the visible light or at least about 90% of the visible light. Non-limiting examples of light absorbing colors include black, dark blue, dark violet, and equivalents or combinations thereof.

Without wishing to limit the present invention to any particular theory, it is believed that the light absorbing second colorant component effectively enhances the ability of the tinted contact lens 40 to change a color of an eye of the wearer of the contact lens relative to the same ability in a substantially identical contact lens absent such light absorbing second colorant component. Moreover, the light absorbing colorant component is believed effective in muting the natural iris color of the wearer. This phenomenon is especially important when the wearer's natural iris is a dark color, for example dark brown. As a specific example, the light absorbing colorant component of the tinted contact lens 40, in FIG. 3, may be able to mute the natural dark brown iris of the wearer, thus permitting the color of the first colorant component, for example blue, to be visible to an ordinary viewer. This muting of the natural color of the iris is an enhanced benefit heretofore unavailable in tinted contact lenses of the prior art.

As described above, the elements of the light absorbing colorant component may be uniformly or non-uniformly distributed within the iris section 24. Preferably, the light absorbing colorant component is substantially uniform across the iris section 24 and has a density in the range of about 5% to about 70%. More preferably, the density of the elements, for example, elements 48 in FIG. 4D, of the light absorbing colorant component is between about 10% to about 50%. As discussed elsewhere herein, the term density as used herein refers to the percentage of the surface area on which the light absorbing color component is located or extends over that the colorant component elements 48 cover. Therefore, a density of 100% represents a complete coverage of the particular area 42 of iris section 24.

Desirably, the light absorbing elements, such as elements 48, of the second colorant component do not substantially overlap the elements 44 of the first colorant component. In this context, “substantially overlap” means that the light absorbing elements 48 of the second colorant component overlap or cover about 50% or more of the total area of the elements 44 of the first colorant component. In a preferred embodiment, the light absorbing elements, 48, of the second colorant component overlap less than about 30% of the total area of the elements, such as elements 44, of the first colorant component.

Enhanced Perception of Depth

In accordance with one aspect of the present invention, the single or multiple colorant components enhance an ordinary viewer's perception of depth within the iris section 24 when the tinted contact lens is worn. This characteristic is an enhanced benefit, heretofore unavailable in tinted contact lenses of the prior art. The configuration of the elements of the colorant component(s) may be, and preferably are, non-uniform across the area of the iris section. Without wishing to limit the invention to any particular theory of operation, it is believed that such non-uniformity in the elements of the colorant component(s) enhances the perception of depth when the contact lens is worn, for example relative to a substantially identical contact lens with a colorant component or colorant components distributed uniformly across the area of the iris section.

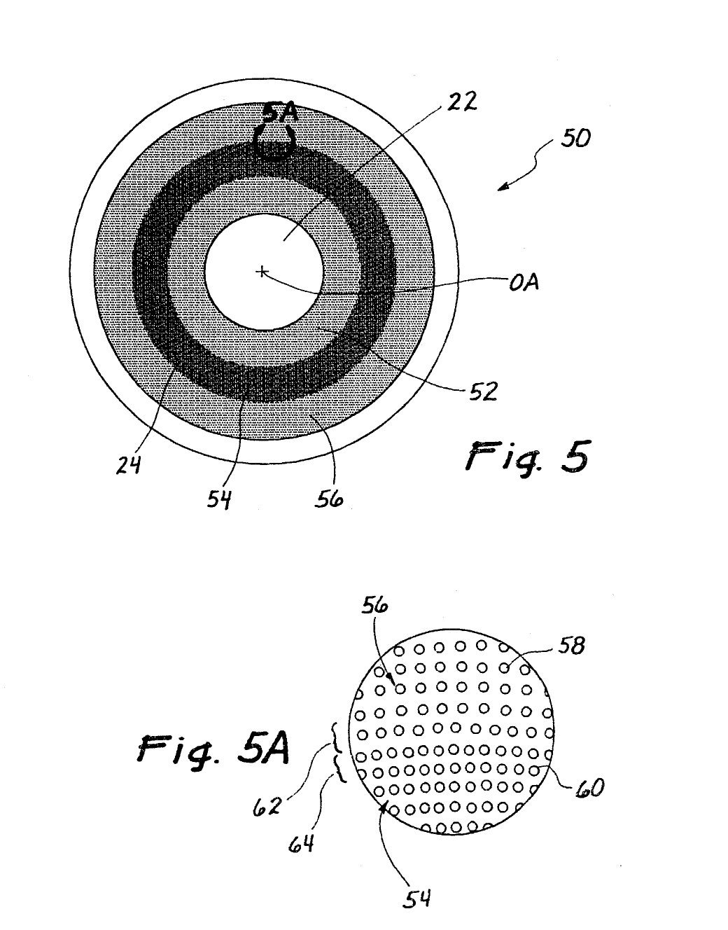

FIG. 5 illustrates a tinted contact lens 50 of the present invention having one or more colorant components in the iris section 24 that are distributed non-uniformly so as to enhance the perception of depth in the contact lens by an ordinary viewer. In this exemplary embodiment, the non-uniformity results from varying the density of the colorant component radially across the iris section 24. As described above, the density of the elements of any of the colorant components in the iris section 24 is the percentage of surface area covered by those elements

In general, or at least in one useful embodiment, the colorant component is desirably less dense, that is has a reduced density, in a portion of the area of the iris section 24 near the pupil section 22 than at a different portion of the area of the iris section farther away from the pupil section. Likewise, in one embodiment, the colorant component is desirably less dense, that is has a reduced density, in a portion near the outer periphery of the iris section 24 than at a different portion of the area of the iris portion farther away from the outer periphery of the iris section. Desirably, the colorant component is less dense both near the pupil section and near the outer periphery of the iris section than between these two portions.

In the illustrated embodiment in FIGS. 5 and 5A, the colorant component(s) in the iris section 24 has an inner portion 52 near the pupil section 22 that is less dense than a middle portion 54 that surrounds the inner portion. Furthermore, an outer portion 56 surrounding the middle portion 54 may have the same density as the inner portion 52, or at least a density that is less than the middle portion 54. In a preferred embodiment, the inner, middle, an outer portions 52, 54, 56 are concentric rings or other patterns extending between the periphery of the pupil section 22 and the outer periphery of the iris section 24.

In one embodiment, the inner portion 52 has a radial dimension that extends or is located in an area between 0% to about 40% of the radial dimension of the iris section 24 as measured from the pupil section 22, that is from the periphery of the pupil section to the outer periphery of the iris section 24. The more dense middle portion 54 desirably has a radial dimension that extends or is located in an area between about 20% or about 25% to about 75% or about 90% of the radial dimension of the iris section 24 as measured from the pupil section 22. Finally, the less dense outer portion 56 has a radial dimension that extends or is located in an area between about 60% to about 100% of the radial dimension of the iris section 24 as measured from the pupil section 22. In terms of the absolute percent of the radial dimension of the iris section 24, both the inner and outer portions 52, 56 take up between 0 and about 40%, while the more dense middle portion 54 takes up between about 20% to about 90%.

In a preferred embodiment, the less dense inner and outer portions 52, 56 have a colorant element density that is less than about 35% or less than about 30% (although greater than 0%). Preferably, the less dense inner and outer portions 52, 56 have densities between about 5% to about 30% or about 35%, and more preferably between about 15% to about 25%. The more dense middle portion 54 desirably has a density of about 35% or more or about 40% or more, and more preferably about 40% to about 90%, and still more preferably about 40% to about 75%. In a particularly useful embodiment, both the inner and outer portions 52, 56 have a colorant element density of about 20%, while the middle portion 54 has a colorant element density of about 60%.

In one embodiment, the transition between the portions of the colorant component having varying densities may be substantially sharp, much as illustrated in FIG. 5. To create such a substantially abrupt transition, for example, FIG. 5A illustrates colorant elements 58 of the outer portion 56 spaced apart to create a first density immediately adjacent to colorant elements 60 of the middle portion 54 that are more densely arranged. The colorant elements 58, 60 in the exemplary embodiment are arranged in concentric circles or other patterns about the optical axis OA. An inner ring 62 of colorant elements 58 of the outer portion 56 is shown immediately adjacent an outer ring 64 of colorant elements 60 of the middle portion 54. When viewed from a greater distance, such as seen in FIG. 5, this transition appears substantially abrupt. Alternatively, however, the transition between the portions of varying density may be more gradual. For example, a transition from a 20% density to a 60% density may include significant portions of the iris section with densities between about 20% or about 25% and about 55% or about 60%. The circumferential spacing between the elements 58 may gradually reduce in magnitude between adjacent concentric rings until the desired circumferential spacing of the colorant elements 60 is attained. Still further, the colorant elements 58, 60 may overlap somewhat so as to blend the transition therebetween.

Ring-Like Structure Formed from a Dark Colorant

In a preferred aspect of the present invention, as, seen in FIG. 6, a tinted contact lens 70 incorporates a dark colorant 72 within the iris section 24. Dark colorant 72 is used in combination with one or more colorant components as described herein. However, to provide for illustrative clarity, in FIG. 6 dark colorant 72 is shown without other colorants. Desirably, the dark colorant 72 extends across an outer portion of the area of the iris section 24 to provide a darkened image or so-called ring-like structure. One or more additional colorants (not shown in FIG. 6) on tinted contact lens 70 extend within the iris section 24 radially outwardly beyond the dark colorant 72. Preferably, the dark colorant 72 is provided within the iris section in a substantially light absorbing color which gives the appearance of a black ring-like structure to an ordinary viewer. It should be noted that translucent and/or opaque colors that are not substantially light absorbing may be employed for the dark colorant 72, although dark opaque colors are considered advantageous because of their light absorbing properties.

The dark colorant 72 may be formed in various ways. For example, the dark colorant 72 may be formed as a solid light absorbing band. Alternatively, the dark colorant 72 may be formed with a series of thin light absorbing bands closely spaced together to give the impression of one band. In the multiple band embodiment, the bands may be provided in different colors, or shades of the same color. Still further, the dark colorant 72 may be formed as a series of spaced-apart segments of color that interact with one another to give the impression of one band to the ordinary viewer.

In a preferred embodiment, as seen in FIG. 6, the dark colorant 72 comprises a series of spaced apart segments 74 at the outer portion of the iris section 24. As illustrated, these segments 74 may be short elongated segments that occasionally overlap one another. The segments 74 are generally radially oriented in their direction of elongation. As illustrated, the segments 74 are desirably non-linear or wavy to enhance the natural appearance of the darkened image in the tinted contact lens 70, although linear segments may also function equivalently, or at least acceptably.

In the preferred embodiment of the contact lens 70, the dark colorant 72 is not immediately adjacent to the outer periphery of the iris section 24. That is, the dark colorant segments 74 do not intersect the outer periphery of the iris section 24, and preferably the segments are at least about 0.1 mm away from the outer periphery. This separation from the outer periphery of the iris section 24 is an enhanced benefit heretofore unavailable in tinted contact lenses of the prior art.

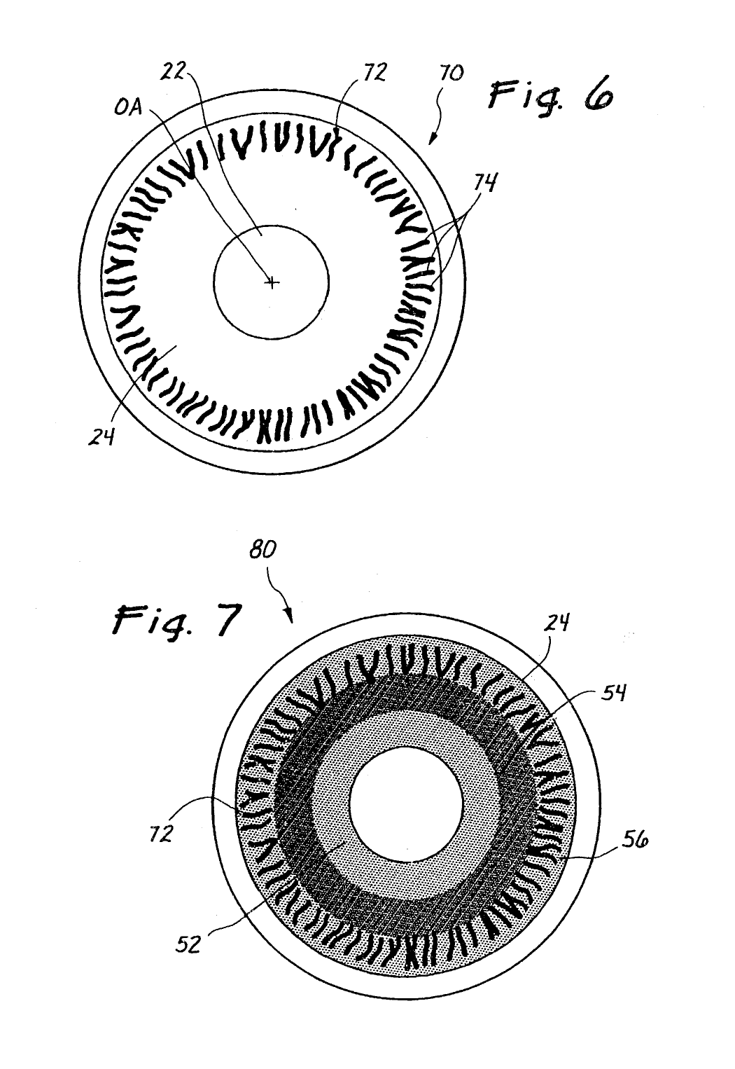

The various colorant components described herein may be utilized alone or in conjunction to create a desired image in the tinted contact lens 11. For example, FIG. 7 illustrates a tinted contact lens 80 that is a combination of the colorant components in FIGS. 5 and 6. More particularly, the colorant component of FIG. 5 having the portions of varying densities is superimposed on the darkened colorant 72 of FIG. 6. The result is an iris section 24 within the contact lens 80 that has an annular darkened image or ring-like structure created by the darkened colorant 72 and concentric regions of varying density that enhance the perception of depth in the iris section created by the portions 52, 54, and 56.

Colored Patterns

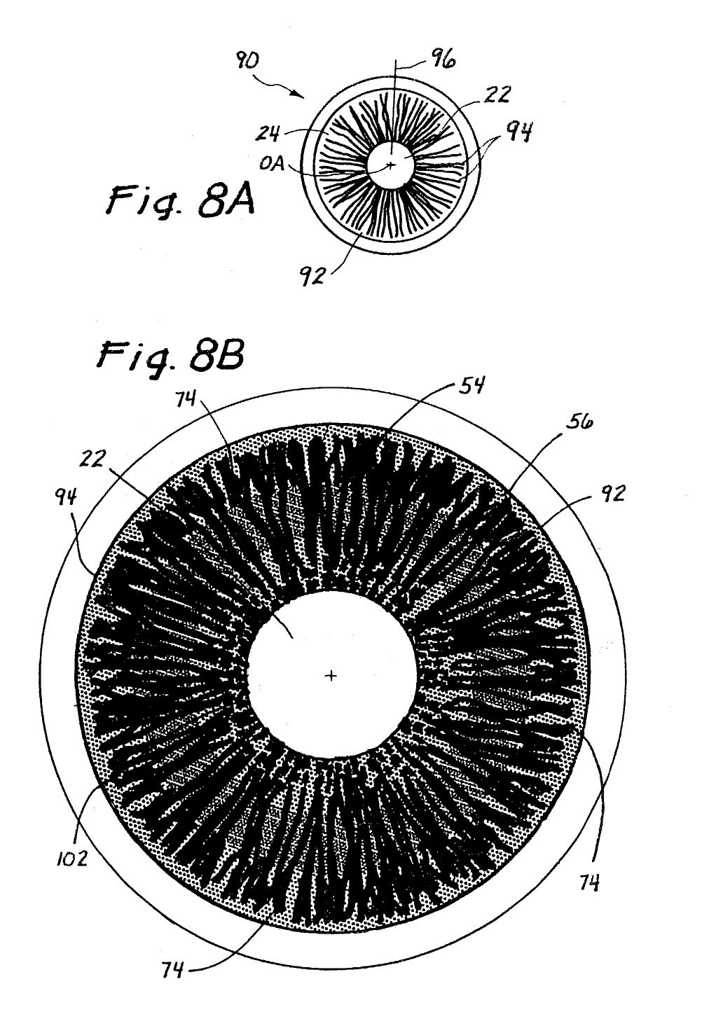

In an exemplary embodiment of the present invention, and as seen in FIGS. 8A and 8B, a tinted contact lens 90 of the present invention incorporates a colored pattern 92 in the iris section 24. The colored pattern 92 desirably extends substantially across the area of the iris section 24 to impart thereto at least a perception of the natural anatomical iris structure. That is, the natural iris exhibits generally radial striations or lines. Namely, the colored pattern 92 extends outwardly from the periphery of the pupil section 22 toward the outer periphery of the iris section 24. In a preferred embodiment, the colored pattern 92 spans more than about 95% of the total radial distance of the iris section 24, that is, substantially the entire distance between the pupil section 22 and outer periphery of the iris section 24. Desirably, the colored pattern 92 does not extend the entire radial dimension of the iris section 24, and in particular does not contact the outer periphery of the iris section. In a particularly useful embodiment, the colored pattern 92 commences at or about the border between the pupil section 22 and the iris section 24 and extends about 96% to about 99% radially outward therefrom into close proximity to the outer periphery of the iris section 24.

The colored pattern 92 has a different color or shade from a single colorant component, and a different color or shade from at least one of multiple colorant components. For example, a tinted contact lens of the present invention may have a single green colorant component and a dark blue colored pattern 92. One or more translucent and/or opaque dyes, pigments, or inks may be employed to form the colored pattern 92, although opaque dyes, pigments, or inks are preferred.

Advantageously, the colored pattern 92 comprises a plurality of colored regions that are substantially completely colored, that is, the regions are solid colors or colors which cover at least about 80% of the regions. The colored regions may be formed of discrete elements. Notwithstanding, the color within the regions may be substantially uniform or substantially non-uniform. For example, parts of the regions may be lightly colored and other parts heavily colored. Preferably, these regions radiate outwardly from the pupil section 22 toward the outer periphery of the iris section 24.

The regions defining the colored pattern 92 may be substantially uniformly shaped, or may be irregularly shaped. As illustrated in FIGS. 8A and 8B, the colored pattern 92 includes regions 94 that are substantially elongated in the radial direction. That is, each region 94 is substantially longer in the radial dimension than in the circumferential dimension. Additionally, the width of each region 94 may vary along its length, which creates a rough, more natural look.

In a preferred embodiment, at least some of the regions 94 extend radially from the periphery of the pupil section 22 into proximity with but not intersecting the outer periphery of the iris section 24. At the same time, some of the regions 94 may extend only partially between the pupil section 22 and the outer periphery of the iris section 24. A particularly useful embodiment that effectively simulates the appearance of the natural iris includes both these regions of different lengths.

Some of the regions 94 overlap one another, although others extend radially outward without overlapping. It should be noted that the regions 94 do not form clusters, or repeating clusters, of an interconnecting network of lines, as in some earlier tinted contact lenses of the prior art. Indeed, as seen in FIG. 8B, no such arrangement is present or discernible.

In one embodiment, as seen in FIG. 8A, a continuous line 96 may be traced from the optical axis OA to the outer periphery of the iris section 24 without intersecting colored pattern 92. Preferably, the continuous line is substantially linear or radial as shown. Stated another way, the colored pattern 92 is desirably configured so that at least one radial plane, parallel to the optical axis OA and extending from the periphery of the pupil section 22 to the outer periphery of the iris section 24, does not intersect any of the regions 94.

It should be noted that FIG. 8A is a somewhat schematic drawing created to more effectively define and describe the regions 94 of the colored pattern 92. FIG. 8B is an illustration of an actual colored pattern 92. It can be seen, therefore, that the elongated radiating regions 94 are not in the actual product wavy lines segments as depicted in FIG. 8A, but instead are substantially non-uniform regions so as to be more natural looking, as in FIG. 8B.

FIG. 9 illustrates a tinted contact lens 100 of the present invention having a colored pattern 102 thereon in which the radiating regions 104 are discontinuous or spaced apart. For example, the regions 104 are shown having discontinuities or spaced apart segments near the periphery of pupil section 22. In a preferred embodiment, the colored regions 104 are discontinuous in a portion of the iris section 24 that is between about 0% or about 0.5% to about 15% as measured radially from pupil section 22. These discontinuities or spaced apart segments 105 enhance the natural appearance of the tinted contact lens 100 and/or advantageously reduce interference with the lens wearer's vision, relative to a similar tinted contact lens in which the colored pattern is completely colored throughout.

A tinted contact lens of the present invention may comprise more than one colored pattern. The multiple colored patterns may be different colors, or may be different shades of same color. Additionally, the multiple colored patterns may overlap or not.

Superposition of Various Colors

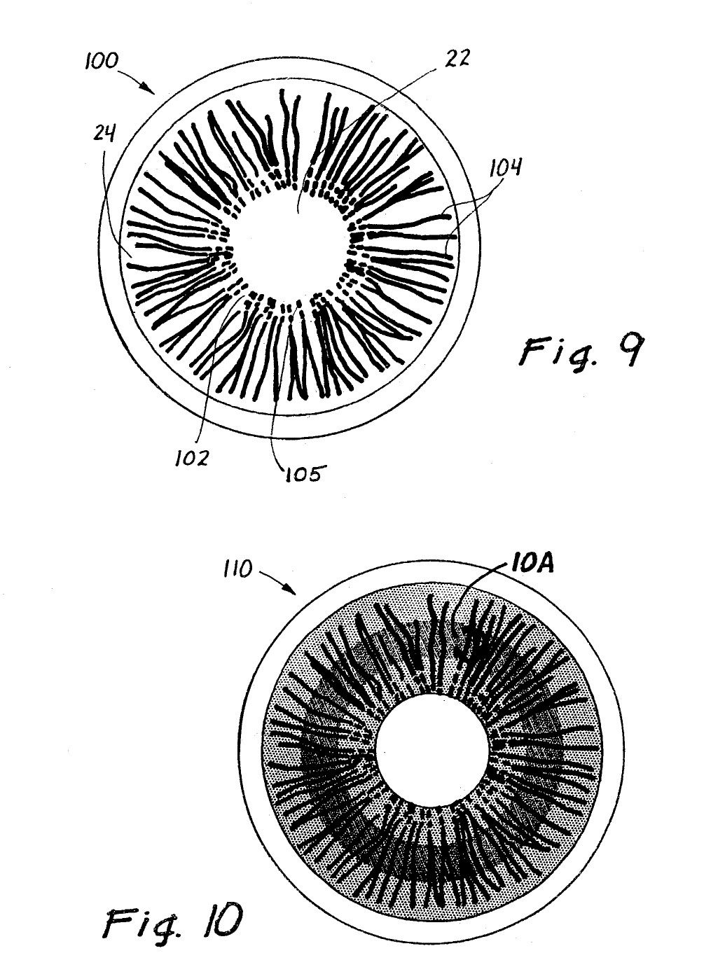

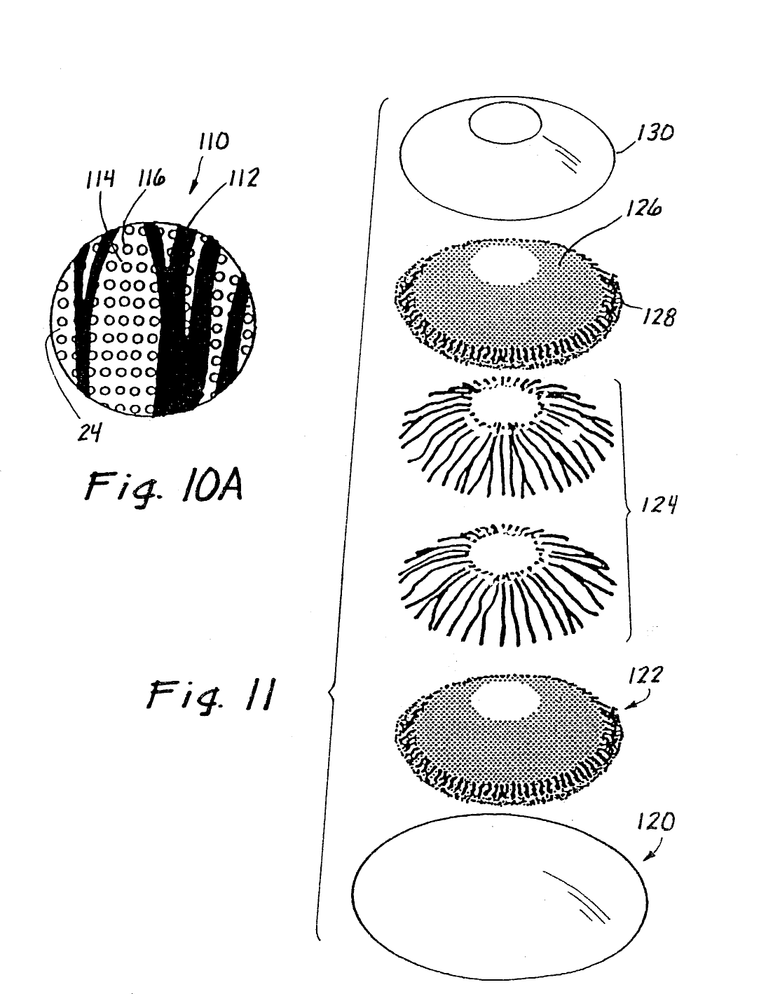

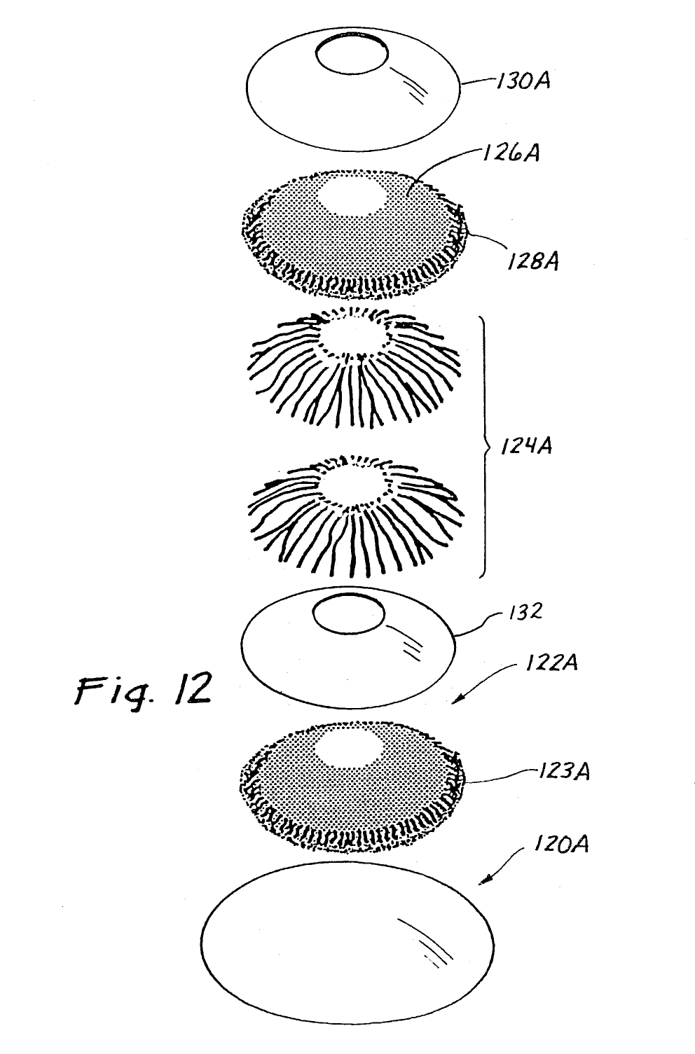

FIG. 10 illustrates a tinted contact lens 110 of the present invention that includes multiple colors, much like the lens 80 shown in FIG. 7. Specifically, the lens 110 includes one or more colorant components as described above with reference to FIGS. 2-4 and a colored pattern as described above with reference to FIGS. 8-9. FIG. 10A is a magnified portion of the iris section 24 of the lens 110 and illustrates colored regions 112 of the colored pattern, and different elements 114, 116 of different first and second colorant components, respectively. It should be understood that the varying regions of different density as described above with respect to FIG. 5 may also be provided in the colorant components. Likewise, the dark colorant forming the ring-like structure as seen in FIG. 6 may also be superimposed on the lens 110 of FIG. 10.

There are different possibilities of colors and shades for the various colorant components and colored patterns of the lenses of the present invention. For example, all of the different components and patterns may be different colors. Desirably, the color of a second colorant component and of the dark colorant should be light absorbing, such as black or dark brown. The colors of the first color components and the colors of the colored patterns may independently be selected from blue, green, red, yellow, white, violet and the like.

For example, a tinted contact lens of the invention comprises a first colorant component having a blue colorant, a colored-pattern having a lighter or darker blue color, another colored-pattern having a light brown or beige color, and a second colorant component having a black colorant and a black dark colorant.

In another example, a tinted contact lens of the invention comprises a first colorant component having a green colorant, a colored-pattern having a lighter or darker green color, another colored-pattern having a light brown or beige color, and a second colorant component having a black colorant and a black dark colorant.

Process of Manufacture

The first colorant component, the second colorant component, the colored-pattern and/or the dark colorant may be provided using any suitable means, e.g., one or more printing techniques, such as conventional techniques well known in the art. See, for example, Thakrar et al, U.S. Pat. No. 5,138,718, the disclosure of which is incorporated in its entirety herein by reference.

In one particularly useful embodiment, a plate or cliche having depressions in the desired pattern is smeared with ink of the desired color. For example, a cliche may have a pattern of the first colorant component. Excess ink is removed by scrapping the surface of the plate with a doctor blade leaving the depression filled with ink. A silicon rubber pad is pressed against the plate to pick up the ink from the depressions and then is pressed against a surface of the contact lens or contact lens substrate to transfer the pattern to the lens. The printed pattern is then cured to render it unremovable from the lens, for example, during use of the lens. In the event that multiple printed patterns are employed, each printed pattern may be cured prior to placing the next printed pattern on the lens. Preferably, all of the printed patterns are placed on the lens, without intermittent curing, and are cured at the same time to render the printed patterns unremovable from the lens.

Of course, either the anterior or posterior surface of the lens or substrate may be printed, but printing the anterior surface is presently preferred. These steps may be repeated for each additional colorant component and pattern. For example, a contact lens of the present invention may be produced using a cliche having the pattern of a colored-pattern, a cliche having a pattern of a dark colorant and a cliche of a second colorant component. In one embodiment, a cliche may have more than one pattern. For example, a cliche may have a pattern of a second, light absorbing colorant component and a pattern for the dark colorant. Also, a cliche may have a pattern of a first colorant component and a pattern for the dark colorant.

The various colorant components and colored patterns may be printed onto a contact lens or contact lens substrate in any order. For example, in one embodiment, a contact lens of the present invention may comprise a first colorant component and one colored pattern. The first colorant component may be the first print onto the lens or substrate and the colored pattern may be the second print onto the lens or substrate. Alternatively, the colored pattern may be the first print onto the lens or substrate and the first colorant component may be the second print.

Preferably, the first print of a contact lens of the present invention is a first colorant component with one colorant with or without a dark colorant; the second print is a colored pattern; the third print is another colored pattern; and the fourth print is a second colorant component comprising a light absorbing colorant with or without a dark colorant.

More preferably, the first print of a contact lens of the present invention includes a first colorant component with one colorant, wherein the colorant is non-uniform, for example, having a lesser density (e.g. 20%) at a portion near the pupil section and the outer periphery of the iris section and a higher density (e.g. 60%) between the lesser density portions with or without a dark colorant; the second print is a colored pattern; the third print is another colored pattern; and the fourth print is a second colorant component comprising a light absorbing colorant with or without a dark colorant. At least one of the prints, and preferably both the first print and the fourth print, include a dark colorant.

In one embodiment, the prints may be formed on the anterior convex side, the posterior concave side and/or both sides of a contact lens. Preferably, the prints are formed on the anterior convex side of the contact lens. The prints may be formed on a dry and/or wet contact lens.

With reference now to FIG. 11, a preferred arrangement of the various colorant components and colored patterns of a tinted contact lens of the present invention is shown. The contact lens comprises a substrate 120 of conventional construction, for example, a conventional rigid or rigid gas permeable or hydrophilic (soft) daily wear or extended wear contact lens, that may or may not provide an optical correction for the wearer. The anterior surface of the substrate 120 is visible and the various colorant components are shown exploded above and are intended to be provided thereon. Of course, as described above, the colorants and colored patterns may be deposited or formed on the posterior surface, or may be sandwiched between two layers of substrates.

In a preferred arrangement, the first deposit on the substrate 120 is a first colorant component 122 of an opaque or translucent substantially reduced light absorbing or substantially non-light absorbing color. A first dark colorant 123, formed of a single color, typically black, is included in the first deposit and is positioned in a ring-like series of segments near the outer periphery of the first colorant component 122, such that the first colorant component surrounds, or extends radially outwardly beyond, the first dark colorant 12. One or more colored patterns 124 are then provided separately from the first colorant component 122. A second colorant component 126 in combination with a second dark colorant 128 defining a ring-like structure, similar to dark colorant 123 is then provided. The second dark colorant 128 is positioned in a ring-like series of segments near the outer periphery of the second colorant component 126, such that the second colorant component surrounds, or extends radially outwardly beyond, the second dark colorant component 128. Finally, an optically clear coating 130 covers the anterior surface of the substrate 120 over the colorant component and colored pattern layers, and preferably does not cover the pupil section, that is the optical zone, of substrate 120. This clear coating 130 is effective to enhance the wearer's comfort while wearing the tinted contact lens.

As mentioned above, various processes for forming the colorant component and colored pattern layers on a contact lens substrate may be utilized and included within the scope of the present invention. In the cliche print (pad printing) method, the layers are placed one by one in the order from the lowest to the highest, and permitted to dry and/or cure between each application. Advantageously, the last layer including the light absorbing color component 126 and dark colorant 128 is formed of a single color, typically black.

Materials

Lenses and inks used to practice this invention are known and described in the art. See, for example, Loshaek U.S. Pat. No. 4,668,240, the disclosure of which is incorporated in its entirety herein by reference. In one embodiment, a lens constructed of a polymer having —COOH, —OH, or —NH₂ groups is printed with ink containing binding polymer having the same functional groups, opaque coloring substance, and a diisocyanate compound. First a solution of binding polymer and solvent is prepared and this solution is mixed with paste containing the coloring substance to form an ink. The preferred binding polymer solutions described in the Loshaek patent have a viscosity of 25,000 CPS. Alternative opaquing methods include use of a laser or finely ground particles. See, for example Neefe U.S. Pat. No. 4,744,647 and Meshel et al U.S. Pat. No. 4,460,523, respectively, the disclosure of each patent is incorporated in its entirety herein by reference.

Preferably, a lens in accordance with the present invention may be constructed from a hydrophilic polymer selected from the group consisting of polyhydroxyethylmethacrylate, methacrylic acid-containing polymers, N-vinylpyrrolidone-containing polymers, acrylamide-containing polymers, polyvinyl alcohol and the like. Lenses including silicone hydrogels may also be used. In one embodiment, the lens is substantially devoid or free of reactive groups. For example, in this embodiment, the lens may be substantially devoid of groups selected from —COOH, —NH—R, NCO and epoxy groups.

Preferably, the ink employed to form the colored elements and patterns of this invention remains substantially hydrophillic on the lens after it is cured. In one embodiment, the ink comprises a pigment; a binding polymer having epoxy groups; and an activation component comprising an amine and is capable of crosslinking the binding polymer. See the commonly assigned U.S. patent application entitled “Coated Contact Lenses and Methods for Making Same” (Attorney Docket No. D-2989), which is being filed in the United States Patent and Trademark Office on even date herewith, the disclosure of which is incorporated in its entirety herein by reference. Pigments of this invention includes metal oxides and/or other coloring substances.

In one embodiment, the binding polymer comprises polymers made up of or obtained from hydrophillic monomers. For example, the binding polymers may be made up of monomers selected from the group consisting of hydrophilic N-vinyl heterocyclic monomers; hydrophilic C₁ to C₆ vinyl ethers; hydrophilic C₁ to C₆ esters of acrylic or methacrylic acid; hydrophilic vinyl monomers; hydrophilic diene monomers; and hydrophilic C₁ to C₆ alkoxy C₁ to C₆ alkyl esters of acrylic or methacrylic acid. Preferably, the binding polymer comprises polyhydroxyethyl methacrylate. The binding polymer component may include units derived from non-hydrophilic monomers or monomeric components in effective amounts, for example, to provide desired property enhancement. The amount of the non-hydrophilic monomers employed preferably is such as to have no substantial detrimental effect on the hydrophilicity of the final crosslinked polymer component.

In one embodiment, the activation component comprises an intermediate compound selected from the group consisting of polyfunctional compounds, such as polyfunctional amines, polyfunctional acids, anhydrides, polyfuntional mercaptans, polyamides, polyfunctional melamine-formaldehyde compounds, polyfunctional urea-formaldehyde compounds, polyfunctional phenol-formaldehyde compounds and mixtures thereof. Useful examples of intermediate compounds include amines, diacids and anhydrides. Non-limiting examples of intermediate compounds include triethylene tetraamine and diethylene triamine. In one embodiment, the intermediate compounds have at least two —NH—R, groups wherein R is hydrogen or C₁ to C₈ alkyl.

Epoxy groups include, for example, glycidyl methacrylate and glycidyl acrylate. Without wishing to limit the invention to any theory or mechanism of operation, it is believed that the activation component cross links the binding polymer by reacting with the epoxy groups located on or within the binding polymers. The lens polymer advantageously does not react to form covalent binds with either the binding polymer or the activation component.

Clear Coating

In one embodiment, the tinted contact lens comprises a clear coating, for example, a substantially optically clear coating. For example, a lens of this invention comprises a first colorant component and a clear coating. The clear coating may have various beneficial effects. For example, clear coating applied between the prints may be effective to enhance the depth effects of the iris section. Preferably, the clear coating is effective to provide increased comfort to the wearer. For example, a tinted contact lens having a clear coating of the present invention is more comfortable to wear than a substantially identical tinted contact lens without the coating. In one embodiment, the coating has a thickness of less than about 20 microns, preferably less than about 10 microns.

In one embodiment, the contact lenses, for example, the tinted contact lenses of the present invention include a plurality of clear coatings, which clear coatings preferably are spaced apart from each other. Advantageously, the clear coatings have two or more refractive indexes. For example, each of the clear coatings has a different refractive index. The different refractive indexes can be achieved, for example, by varying the composition of the clear coatings and/or varying the conditions at which each of the clear coatings is applied to the lens. A tinted contact lens including two clear coatings having different refractive indexes advantageously provides an enhanced perception of depth and/or an enhanced perceived three-dimensional effect relative to an identical tinted contact lens with two clear coatings having the same refractive index. The clear coatings may be located directly adjacent each other and/or separated from each other by one or more of the colorant components and/or colored-patterns of the tinted contact lens.

FIG. 12 illustrates an embodiment of the present invention described hereinabove. Each of the elements and associated reference numerals shown and referred to in FIG. 11 are also present in FIG. 12, with the reference numerals being identified with the additional character “A”.

As shown in FIG. 12, an additional clear coating 132 is provided and is located between the first colorant component 122A and the one or more colored patterns 124A. The additional clear coating 132 has a different refractive index than does clear coating 130A. For example, the indexes of refraction of coating 132 and coating 130 differ by at least about 0.01 or about 0.015. The different indexes of refraction are obtained by using different coating compositions for coatings 132 and 130A.

The effect of having two spaced apart different index of refraction clear coatings 132 and 130A, as shown in FIG. 12, is to give the contact lens, when worn on an eye, an enhanced perception of depth (perceived by a person viewing the lens being worn by another) and/or an enhanced perceived three-dimensional effect (perceived by a person viewing the lens being worn by another). Such enhancement or enhancements are relative to an identical contact lens or tinted contact lens with clear coatings having the same refractive index.

In one embodiment, the clear coating or coatings may be coated onto the contact lens in any suitable manner. For example, the clear coating may be applied to the anterior convex side, the posterior concave side and/or both sides of the contact lens. Although a clear coating may be sandwiched between two prints, it is preferable that the coating is applied as a top layer. For example, a tinted contact lens of the present invention may be printed initially with a first colorant component and a dark colorant, then a colored pattern, then another colored pattern, then a second colorant component comprising a color absorbing colorant and a dark colorant. Finally, these prints are layered with a clear coat. Preferably, the prints and the clear coatings are on the anterior side of the contact lens. The tinted contact lens may further be coated with a clear coat on the other side, which may not have any prints, for example the posterior side of the contact lens.

In one embodiment, the clear coating may be layered onto the contact lens by a conventional coating process, including a curing step in which the coating preferably is cross-linked.

The clear coating may be formed from various materials known in the art. See, for example, Valint et al U.S. Pat. No. 6,213,604; Fuhrman U.S. Pat. No. 4,558,931; and Merrill U.S. Pat. No. 4,099,859, the disclosures of which are incorporated in their entireties herein by reference.

Preferably, the coating comprises a hydrophilic polymeric material. For example, the clear coating of this invention preferably remains substantially hydrophilic on the lens after it is cured. In one embodiment, the clear coating comprises binding polymers having epoxy groups; an activation component comprising an amine and is capable of crosslinking the binding polymers; and pigments. See commonly assigned U.S. application Ser. No. (Attorney's Docket No. D-2989) entitled “Coated Contact Lenses and Methods for Making Same”, which is being filed on even date herewith.

In one embodiment, the binding polymer comprises polymers made up of hydrophillic monomers. For example the polymers may be made up of monomers selected from the group consisting of hydrophilic N-vinyl heterocyclic monomers; hydrophilic C₁ to C₆ vinyl ethers; hydrophilic C₁ to C₆ esters of acrylic or methacrylic acid; hydrophilic vinyl monomers; hydrophilic diene monomers; and hydrophilic C₁ to C₆ alkoxy C₁ to C₆ alkyl esters of acrylic or methacrylic acid. Preferably, the binding polymer comprises hydroxyethyl methacrylate. The binding polymer component may include units derived from non-hydrophilic monomers or monomeric components in effective amounts, for example, to provide desired property enhancement. The amount of the non-hydrophilic monomers employed preferably is such as to have no substantial detrimental effect on the hydrophilicity of the final crosslinked polymer component.

In one embodiment, the activation component comprises an intermediate compound selected from the group consisting of polyfunctional compounds, such as polyfunctional amines, polyfunctional acids and anhydrides, such as amines, diacids and anhydrides. Non-limiting examples of intermediate compounds include triethylene tetraamine and diethylene triamine. In one embodiment, the intermediate compounds have at least two —NH—R, groups wherein R is hydrogen or C₁ to C₈ alkyl.

Epoxy groups include, for example, glycidyl methacrylate and glycidyl acrylate. Without wishing to limit the invention to any theory or mechanism of operation, it is believed that the activation component cross links the binding polymer by reacting with the epoxy groups located on or within the binding polymers. The lens polymer advantageously does not react to form covalent binds with either the binding polymer or the activation component.

While this invention has been described with respect to various specific examples and embodiments, it is to be understood that the invention is not limited thereto and that it can be variously practiced within the scope of the following claims.

What is claimed is:

1. A tinted contact lens comprising:
a pupil section;
an iris section having an area and circumferentially surrounding the pupil section; and
a colorant component extending across a major portion of the area of the iris section to provide a color to the iris section, the colorant component being configured to provide at least one additional benefit to the contact lens.

2. The tinted contact lens of claim 1 wherein the colorant component is configured to enhance the natural appearance of the iris section when the contact lens is in an eye.

3. The tinted contact lens of claim 1 wherein the colorant component is configured to provide the iris section with an enhanced perception of depth when the contact lens is in an eye.

4. The tinted contact lens of claim 1 wherein the colorant component is configured to provide a darkened-image within an outer portion of the iris section.

5. The tinted contact lens of claim 1 wherein the color provided to the iris section by the colorant component is the color to which a wearer of the contact lens wishes to change an iris of an eye by wearing the contact lens.

6. The tinted contact lens of claim 1 wherein the colorant component extends across substantially all of the area of the iris section.

7. The tinted contact lens of claim 1 wherein the colorant component is non-uniform across the area of the iris section.

8. The tinted contact lens of claim 7 wherein the colorant component is sufficiently non-uniform across the area of the iris section to provide the iris section with an enhanced perception of depth when the contact lens is in an eye relative to a substantially identical contact lens with a uniform colorant component across the area of the iris section.

9. The tinted contact lens of claim 7 wherein the colorant component has a non-uniform density across the area of the iris section.

10. The tinted contact lens of claim 7 wherein the colorant component is present at a reduced density at a portion of the area of the iris section near the pupil section than at a different portion of the area of the iris section further away from the pupil section.

11. The tinted contact lens of claim 7 wherein the colorant component is present at a reduced density at a portion of the area of the iris section near an outer periphery of the iris section than at a different portion of the area of the iris portion further away from the outer periphery of the iris section.

12. The tinted lens of claim 7 wherein the colorant component has a minimum density of about 35% or less and a maximum density of about 40% or more.

13. The tinted contact lens of claim 1 wherein the colorant component is a single colorant.

14. The tinted contact lens of claim 1 which further comprises a peripheral section circumferentially surrounding the iris section and being substantially free of colorant component.

15. The tinted contact lens of claim 1 wherein the colorant component includes a dark colorant extending across a portion of the area of the iris section to provide a darkened-image within an outer portion of the iris section.

16. The tinted contact lens of claim 1 which further comprises at least one colored pattern extending across a portion of the area of the iris section to impart to the iris section at least a perception of a structure of an iris of an eye, the at least one colored pattern comprising a different color than present in the colorant component.

17. The tinted contact lens of claim 16 wherein the at least one colored pattern includes two colored patterns.

18. The tinted contact lens of claim 16 wherein the at least one colored pattern extends outwardly from a periphery of the pupil section toward an outer periphery of the iris section.

19. The tinted contact lens of claim 18 wherein the at least one colored pattern extends more than about 95% of the radial distance between the periphery of the pupil section and the outer periphery of the iris section.

20. The tinted contact lens of claim 18 wherein the at least one colored pattern does not contact the outer periphery of the iris section.

21. The tinted contact lens of claim 1 which further comprises a second colorant component, different from the colorant component, extending across a major portion of the area of the iris section, the second colorant component being light absorbing and effective to enhance the ability of the contact lens to change a color of an eye wearing the contact lens relative to a substantially identical contact lens without the second colorant component.

22. The tinted contact lens of claim 21 wherein the second colorant component extends across substantially all of the area of the iris section.

23. The tinted contact lens of claim 21 wherein the second colorant component is substantially uniform across the area of the iris section.

24. The tinted contact lens of claim 21 wherein the second colorant component has a density in a range of about 5% to about 90%.

25. The tinted contact lens of claim 1 which further comprises a substantially optically clear coating covering the colorant component, the coating being effective to provide increased comfort in wearing the tinted contact lens relative to wearing a substantially identical tinted contact lens without the coating.

26. The tinted contact lens of claim 25 wherein the coating has a thickness of less than about 20 microns.

27. The tinted contact lens of claim 25 wherein the colorant component is located on an anterior surface of a contact lens substrate and the coating forms the anterior surface of the contact lens.

28. The tinted contact lens of claim 1 which further comprises a dark colorant, other than the colorant component, configured to provide a darkened-image within an outer portion of the iris section.

29. The tinted contact lens of claim 1 which further comprises a dark colorant, other than the colorant component, extending across a portion of the area of the iris section to provide a darkened-image within an outer portion of the iris section.

30. A tinted contact lens comprising:
a pupil section having a periphery;
an iris section having an area, an outer periphery and circumferentially surrounding the pupil section; and
at least one colored pattern extending across a portion of the area of the iris section to impart to the iris section at least a perception of a structure of an iris of an eye, the at least one colored pattern comprising a plurality of substantially completely colored regions, each of the plurality of regions becoming a series of spaced apart segments near the periphery of the pupil section.

31. The tinted contact lens of claim 30 wherein the at least one colored pattern includes two colored patterns.

32. The tinted contact lens of claim 31 wherein each of the two colored patterns is differently colored.

33. The tinted contact lens of claim 32 wherein the at least one colored pattern extends outwardly from a periphery of the pupil section toward an outer periphery of the iris section.

34. The tinted contact lens of claim 33 wherein the at least one colored pattern extends more than about 95% of the radial distance between the periphery of the pupil section and the outer periphery of the iris section.

35. The tinted contact lens of claim 30 wherein the at least one colored pattern does not contact the outer periphery of the iris section.

36. The tinted contact lens of claim 30 wherein the at least one colored pattern is configured so that at least one location a radial plane, parallel to a central optical axis of the tinted contact lens, extending from the periphery of the pupil section to the outer periphery of the iris section does not intersect the at least one colored pattern.

37. The tinted contact lens of claim 30 which further comprises a peripheral section circumferentially surrounding the iris section and being substantially free of the at least one colored pattern.

38. The tinted contact lens of claim 30 which further comprises a colorant component extending across at least a portion of the area of the iris section to provide a color to the iris section.

39. The tinted contact lens of claim 38 which further comprises a second colorant component, different from the colorant component, extending across at least a portion of the area of the iris section, the second colorant component being light absorbing and effective to enhance the ability of the contact lens to change a color of an eye wearing the contact lens relative to a substantially identical contact lens without the second colorant component.

40. The tinted contact lens of claim 38 wherein the colorant component extends across substantially all of the area of the iris section.

41. The tinted contact lens of claim 38 wherein the colorant component has a density in a range of about 5% to about 90%.

42. The tinted contact lens of claim 30 which further comprises a substantially optically clear coating covering the at least one colored pattern, the coating being effective to provide increased comfort in wearing the tinted contact lens relative to wearing a substantially identical tinted contact lens without the coating.

43. The tinted contact lens of claim 42 wherein the coating has a thickness of less than about 20 microns.

44. The tinted contact lens of claim 42 wherein the coating forms the anterior surface of the contact lens.

45. The tinted contact lens of claim 30 which further comprises a dark colorant, other than the at least one colored pattern, configured to provide a darkened-image within an outer portion of the iris section.

46. The tinted contact lens of claim 30 which further comprises a dark colorant, other than the at least one colored pattern, extending across a portion of the area of the iris section to provide a darkened-image within an outer portion of the iris section.

47. A tinted contact lens comprising:
a pupil section;
an iris section having an area and circumferentially surrounding the pupil section;
a first colorant component positioned to provide a color to at least a portion of the iris section; and
a second colorant component, different from the first colorant component, extending across a major portion of the area of the iris section, the second colorant component being light absorbing and effective to enhance the ability of the contact lens to change a color of an eye wearing the contact lens relative to a substantially identical contact lens without the second colorant component.

48. The tinted contact lens of claim 47 wherein the second colorant component extends across substantially all of the area of the iris section.

49. The tinted contact lens of claim 47 wherein the second colorant component is substantially uniform across the area of the iris section.

50. The tinted contact lens of claim 47 wherein the second colorant component has a density in a range of about 5% to about 70%.

51. The tinted contact lens of claim 47 which includes a plurality of distinct colorants.

52. The tinted contact lens of claim 47 which further comprises a substantially optically clear coating covering the first and second colorant components, the coating being effective to provide increased comfort in wearing the tinted contact lens relative to wearing a substantially identical tinted contact lens without the coating.

53. The tinted contact lens of claim 52 wherein the coating has a thickness of less than about 20 microns.

54. The tinted contact lens of claim 52 wherein the second colorant component is located on an anterior surface of a contact lens substrate and the coating forms the anterior surface of the contact lens.

55. The tinted contact lens of claim 47 which further comprises a dark colorant, other than the first and second colorant components, configured to provide a darkened-image within an outer portion of the iris section.

56. The tinted contact lens of claim 47 which further comprises a dark colorant, other than the first and second colorant components, extending across a portion of the area of the iris section to provide a darkened-image within an outer portion of the iris section.

57. A tinted contact lens comprising:
a pupil section;
an iris section having an area and circumferentially surrounding the pupil section;
a colorant component positioned to provide a color to at least a portion of the iris section; and
a substantially optically clear coating covering the colorant component, the coating being effective to provide increased comfort in wearing the tinted contact lens relative to wearing a substantially identical tinted contact lens without the coating.

58. The tinted contact lens of claim 57 wherein the coating has a thickness of less than about 20 microns.

59. The tinted contact lens of claim 57 wherein the coating has a thickness of less than about 10 microns.

60. The tinted contact lens of claim 57 wherein the colorant is located on an anterior surface of a contact lens substrate and the coating forms the anterior surface of the contact lens.

61. The tinted contact lens of claim 57 wherein the coating forms the anterior surface of the contact lens.

62. The tinted contact lens of claim 57 wherein the coating comprises a hydrophilic polymeric material.

63. The tinted contact lens of claim 57 wherein the coating comprises a cross-linked hydrophilic polymeric material.

64. The tinted contact lens of claim 57 which further comprises a dark colorant, other than the component, configured to provide a darkened-image within an outer portion of the iris section.

65. The tinted contact lens of claim 57 which further comprises a dark colorant, other than the colorant component, extending across a portion of the area of the iris section to provide a darkened-image within an outer portion of the iris section.

66. The tinted contact lens of claim 57 further comprising an additional substantially optically clear coating having a different refractive index relative to the substantially optically clear coating.

67. The tinted contact lens of claim 57 further comprising an additional substantially optically clear coating spaced apart from the substantially optically clear coating.

68. The tinted contact lens of claim 67 wherein the substantially optically clear coating and the additional substantially optically, clear coating have different refractive indexes.

69. A tinted contact lens comprising:
a pupil section;
an iris section having an area, an outer periphery, and circumferentially surrounding the pupil section; and
a dark colorant configured to provide a darkened-image within an outer portion of the iris section.

70. The tinted contact lens of claim 69 which further comprises a colorant component extending across a portion of the iris section.

71. The tinted contact lens of claim 69 which further comprises a peripheral section circumferentially circumscribing and immediately adjacent the iris section.

72. The tinted contact lens of claim 69 wherein the peripheral section is free of the dark colorant.

73. The tinted contact lens of claim 69 wherein the darkened image comprises a series of spaced apart segments of the dark colorant.

74. A contact lens comprising:
a pupil section;
an iris section having an area and circumferentially surrounding the pupil section;
a substantially optically clear coating covering at least a portion of the iris section; and
an additional substantially optically clear coating covering at least a portion of the iris section and having a different refractive index than the substantially optically clear coating.

75. The contact lens of claim 74 wherein the additional substantially optically clear coating is spaced apart from the substantially optically clear coating.

76. The contact lens of claim 74 wherein the pupil section is substantially free of the substantially optically clear coating and the additional substantially optically clear coating.

77. The contact lens of claim 74 wherein the substantially optically clear coating and the additional substantially optically clear coating each comprise a hydrophilic polymeric material.

78. The contact lens of claim 74 wherein the substantially optically clear coating and the additional substantially optically clear coating each comprise a cross-linked hydrophilic polymeric material.

79. A process for making a tinted contact lens having a pupil section, and an iris section having an area and circumferentially surrounding the pupil section, the process comprising providing a colorant component extending across at least a major portion of the area of the iris section to provide a color to the iris section, the colorant component being configured to provide at least one additional benefit to the contact lens.

80. The process of claim 79 wherein the at least one additional benefit comprises enhancing the perception of depth.

81. The process of claim 80 wherein the colorant component is provided at different densities across the iris section.

82. The process of claim 79 which further comprises providing a dark colorant within an outer portion of the iris section.

83. The process of claim 82 wherein the step of providing a dark colorant comprises providing a plurality of spaced apart segments around the outer portion of the iris section, provided that the segments are located within the iris section.

84. The process of claim 79 which further comprises providing a light absorbing colorant component extending across a major portion of the area of the iris section.

85. The process of claim 79 which further comprises providing a colored pattern across the iris section, the colored pattern being configured to simulate the structure of an iris of an eye.

86. The process of claim 79 which further comprises providing a clear coating over the colorant component.
